(19) United States
(12) Patent Application Publication
(10) Pub. No.: US 2015/0254973 A1
(43) Pub. Date: Sep. 10, 2015

(54) ARRANGEMENT COMPRISING AT LEAST ONE FIELD DEVICE, AT LEAST ONE SENSOR, OR SIGNAL, REGISTERING UNIT ASSOCIATED WITH SUCH AND AT LEAST ONE FUNCTION BLOCK

(71) Applicant: ENDRESS+HAUSER GMBH+CO. KG, Maulburg (DE)

(72) Inventors: Dietmar Fruhauf, Lorrach (DE); Michael Konrad, Pfronten (DE); Marc Baret, Kembs (FR)

(21) Appl. No.: 14/431,568

(22) PCT Filed: Aug. 28, 2013
(86) PCT No.: PCT/EP2013/067790

§ 371 Date: Mar. 26, 2015

(30) Foreign Application Priority Data
Sep. 28, 2012 (DE) 10 2012 109 227.3

(51) Int. Cl. G08C 17/02

(52) U.S. Cl. CPC G08C 17/02; H04W 84/18

(57) ABSTRACT

In an arrangement (1) comprising at least one field device (2), at least one sensor, or signal, registering unit (3,3a,3b,3c) associated or associable therewith and at least one function block (10,10a,10n), at least one mobile computer unit (4) is provided for performing calculations and/or evaluations. The at least one sensor, or signal, registering unit (3,3a,3b,3c) and the at least one mobile computer unit (4) comprise for wireless communication with one another, in each case, at least one system (7,7a,7b,7c,40) for wireless sending and receiving of data and/or signals.

The invention relates to an arrangement comprising at least one field device, at least one sensor, or signal, registering unit associated with such and at least one function block, a method for checking a measuring chain in a plant comprising at least one field device with at least one sensor, or signal, registering unit associated with such and at least one control system, wherein the control system is connected by conductor with the field device and the sensor, or signal, registering unit for receiving measured values, as well as a method for implementing SIL-measures in a plant comprising at least two field devices with at least one respective, associated sensor, or signal, registering unit and at least two function blocks.

Arrangements with at least one field device and at least one sensor, or signal, registering unit associated with such are known in the state of the art. The terminology, field devices, means all possible types of devices and systems, which work near to the process, such as, for example, sensors, actuators, especially valves, stirrers, pumps, motors, gateways, etc. In order to ascertain their state, sensor, or signal, registering units are usually associated with field devices. In a plant with one or more field devices, it is necessary ongoing to check the registered measured values, respectively signals, in order to detect errors early. For this, it is known to check the measuring chain of the field device from a central site, for example, a control room. This checking can extend right up to the control room. Furthermore, it is known to provide display means on-site and to simulate measured values at the sensor, or signal, registering unit. The providing of display means on-site on the respective field devices involves great effort and correspondingly high costs. Furthermore, a read off of the respective display means as well as likewise the sensor, or signal, registering unit at the field device is required, a task which can be problematic in the case of poor access by interaction systems, respectively to the display means of the field devices, respectively the sensor, or signal, registering unit. There is here especially the danger of interaction errors during and after the simulating of the measured values at the sensor, or signal, registering unit. The known arrangements lack, furthermore, the opportunity for sending back information from the central location, such as the control room, to the field devices. An addressing of the field devices from the control room, for example, in the case of arising errors, is in the case of the known arrangements and plants not possible, respectively not provided.

Known, furthermore, is to integrate into a field device safety functions, respectively so-called SIL-measures, thus measures to reduce to a representable measure the dangers for human, environment and tangible assets, which can occur in the case of malfunctions of processes and systems. A retrofitting of SIL-functionality into a field device is only possible with considerable developmental effort. In IEC 61508, a standard, in which the functional safety of safety related electrical/electronic/programmable electronic systems is defined, currently, four SILs (safety integrity level) are defined. A SIL is defined by the complexity of the field device, by the architecture of the measuring arrangement and by the probability of the occurrence of unrecognized errors, which degrade the safety function. The higher the safety integrity level of a safety-referenced system, the smaller is the probability that it will not execute the required safety functions, when required. Described in this standard is the type of risk evaluation as well as measures for design of corresponding safety functions of sensors, logic processing as well as especially actuators as regards prevention of systematic errors and containment of stochastic errors.

Disadvantageous is that large amounts of resources are required and must be made available in the field devices for the integration of SIL-measures. Furthermore, changes of once integrated SIL-measures prove to be extremely complicated.

An object of the present invention, consequently, is to provide an arrangement not having the mentioned disadvantages and comprising at least one field device with at least one associated or associable sensor, or signal, registering unit and at least one function block. Furthermore, an object of the invention is to provide a method for checking a measuring chain in a plant equipped with such an arrangement, as well as a method for implementing SIL-measures in a plant equipped with such an arrangement, wherein communication with the field device, respectively at least one sensor, or signal, registering unit and/or function blocks of the field device is possible in simple manner.

The object is achieved for an arrangement as defined in the preamble of claim 1 by features including that at least one mobile computer unit is provided for performing calculations and/or evaluations and the at least one sensor, or signal, registering unit and the at least one mobile computer unit include for wireless communication with one another, in each case, at least one system for wireless sending and receiving of data and/or signals. In the case of a method for checking a measuring chain in a plant as defined in the preamble of claim 6, the object is achieved by features including that the sensor, or signal, registering unit registers a signal of the field device, transmits such to a mobile computer unit wirelessly and the mobile computer unit calculates therefrom a theoretical measured value and compares such with the current measured value of the field device received at the control system. For a method for implementing SIL-measures in a plant as defined in the preamble of claim 9, the object of the invention is achieved by features including that a system for the wireless sending and receiving of signals of the function blocks transmits wirelessly to a mobile computer unit and the mobile computer unit calculates an actual value therefrom and compares such with a predeterminable or predetermined, desired value. Further developments of the invention are set forth in the dependent claims.

In this way, there is created an arrangement having at least one field device, at least one sensor, or signal, registering unit associated or associable therewith and at least one function block, which can be accessed wirelessly by the mobile computer unit. Thus, communication with the sensor, or signal, registering unit and/or the at least one function block can occur, in order to be able to transmit and receive data and/or signals in both directions, thus from and to the mobile computer unit. In this way, it is possible to detect error within the signal transmission, or measuring, chain, such as an interruption of the signal transmission, respectively measuring chain, as well as device, or measurement, error or also error at both ends of the signal transmission, or measuring, chain. Furthermore, signals, respectively data, can be fed into the field devices via the respective sensor, or signal, registering units and/or function blocks of the field device. In the mobile computer unit, it is possible directly on-site after registering the data and signals of the sensor, or signal, registering unit to perform calculations and evaluations, so that a theoretical measured value can be calculated. Advantageously, the mobile computer unit includes at least one system for wireless data communication with a control system, especially a control room. This receives, by wire, current measured values from the respective field device. The received current measured values can be sent wirelessly from the control room to the mobile computer unit, so that it is possible in the mobile computer unit to compare the there calculated, theoretical, measured value with the current measured value of the field device received at the control room and thereby to make deductions concerning possible error in the measuring chain between the field device and the control room. In order to be able to read out the signals from the sensor, or signal, registering unit, it is, thus, no longer necessary to access field devices manually on-site in the plants or to provide display systems there. Rather, it is through the wireless communicating of the sensor, or signal, registering unit, respectively the function blocks of the field device, with the mobile computer unit possible also to read out essentially inaccessible field devices in a plant and to service them via the mobile computer unit. Via the mobile computer unit, it is, furthermore, possible not only to send communications to the control system, but also to send communications from the control system back to the field devices. Within the range of the wireless transmission system of the mobile computer unit, then a checking of the total measuring chain from the field device to the control system, especially a control room, is possible. In such case, all participating components, such as, for example, isolators, barriers, couplers etc., can likewise be checked, in order to detect whether possible errors occur in the signal transmission, respectively measuring, chain and in the region of which components of the signal transmission-, respectively measuring, chain these lie. In such case, no direct engagement in the particular field device is required, but, instead, only the providing of a system for wireless communicating with the mobile computer unit.

The mobile computer unit can comprise at least one display means and/or at least one memory means and/or at least one wireless Internet, respectively WLAN, connection system. In the case of providing a memory means, an option is to store the measurement results and to save such for statistics as well as safety documentation. By providing display means, it is, furthermore, possible to read out from the mobile computer unit also on-site, thus not only via communication with the control system. Alternatively or supplementally, via a wireless Internet, or WLAN, connection system, an accessing of the mobile computer unit via the Internet can be created, so that the mobile computer unit can also be read-out in this way and, in given cases, the particular field device accessed, respectively its sensor, or signal, registering unit, respectively function blocks addressed and/or programmed.

The system is additionally advantageous for the wireless sending and receiving of data and/or signals in the range of the sensor, or signal, registering unit having at least one function block and/or a sensor part connectable or connected for providing wireless access of the mobile computer unit to the function block and/or the sensor part. In this way, the mobile computer unit can directly access the at least one function block of the field device and register signals and/or data, respectively send such to the at least one function block. Thus, also in SIL-applications a checking of the total measuring chain from the field device, respectively the sensor, or signal, registering unit, respectively the at least one function block of the field device through to the control system is possible. All safety-relevant components can, thus, be checked and monitored in an ongoing manner, in order to be able to turn off or influence in other manner the field devices in the case of occurrence of errors. SIL-safety can be assured by ongoing communication between the field device and the mobile computer unit, wherein, for example, in the case where the mobile computer unit loses communication with the field device, an error signal is automatically issued. Furthermore, it can be provided that in the case of loss of communication with the mobile computer unit, the field device goes into an earlier defined state, such that such an error is, on the one hand, immediately detectable and, on the other hand, no risk comes from the respective field device, the defined state being a risk free state. Especially, it can be provided that all field devices, which can be addressed from the mobile computer unit, go into a predefined state upon their removal. The particular predefined state is especially the state specified by the SIL-guidelines for the particular field device.

In the method for implementing SIL-measures in a plant, signals of the individual function blocks of the field devices are transmitted to the mobile computer unit. The mobile computer unit can, thus, access a number of function blocks of a plurality field devices and communicate with these wirelessly. A calculating of actual values occurs in the mobile computer unit based on the signals obtained from the individual function blocks. Advantageously stored in the mobile computer unit are desired values for the individual function blocks, so that the mobile computer unit can perform a desired versus actual value comparison. This provides an option of detecting possibly occurring errors and of accessing the function blocks, respectively the field devices, especially via the mobile computer unit, in order to correct the error or, in given cases, to turn off the field device or to place it in a safe state.

Since the SIL-measures must no longer occur through corresponding implementing of components, respectively program executions in the field devices, but, instead, the SIL-measures run, respectively are implemented, in the mobile computer unit and ongoingly signals of the function blocks of the field device are queried from the mobile computer unit, SIL-functionality can be retrofitted in any field devices without problem through the mobile computer unit, wherein only a system for the wireless sending and receiving of signals of the function blocks in connection with a mobile computer unit must be provided, which likewise enables a wireless communication, respectively comprises a corresponding system for the wireless sending and receiving of data and/or signals, from the, respectively to the, function blocks. Compared with implementing measures for fulfilling SIL-functionality in field devices, additionally costs can be saved, in that a plurality of field devices in the range of the mobile computer unit obtain the SIL-functionality via the mobile computer unit. The otherwise required resources for implementing SIL-functionality in the individual field devices can thereby be reduced to providing the respective system for the wireless communicating with the mobile computer unit. Furthermore, it is advantageously possible to increase redundancy as much as desired, in order to achieve a desired SIL-class. The higher the SIL-class, the smaller is the probability that the particular field device, respectively the function blocks of such, will not execute the required safety function.

By providing the mobile computer unit, it is possible to ascertain data and signals of the field devices and, upon providing display means, to be able to display such. Advantageous, furthermore, is the use of more than one mobile computer unit in conjunction with a plurality of field devices. In this way, not only availability of measured values, respectively data and/or signals, increases, but also a comparison of the ascertained values of the individual mobile computer units can be performed and, for example, a two out of three decisions made.

For checking the sensor, or signal, registering unit and/or an analog-digital converter unit for converting analog sensor signals into digital signals, a stimulus can be produced on the output of the field device and the measured response signal compared with a calculated signal of the sensor, or signal, registering unit. The control system reacts to the stimulus produced on the output of the field device, so that in the case of a known control system behavior the response of the sensor, or signal, registering unit can be predicted and compared with the measured value. In this way, an inference can be drawn concerning the accuracy of measurement of the sensor, or signal, registering unit. Furthermore, an opportunity is provided to register and especially to document the behavior of the total measuring path as a result of the stimulus produced on the output of the field device.

Additionally advantageous is to provide encrypted data- and/or signal transmission. In the case of wireless communication between the mobile computer unit and the sensor, or signal, registering unit, respectively the function blocks, otherwise the data and signals communicated from and to the mobile computer unit could be tapped and, in given cases, tinkered with. Especially in the case of a communicating of the mobile computer unit via the Internet, the providing of encrypted data, respectively signal transmission is advantageous, in order to prevent malicious tinkering. Thus, encrypting of data, respectively signals, can increase security against tinkering with the field device.

The invention will now described in greater detail based on examples of embodiments in the drawing, the figures of which show as follows:

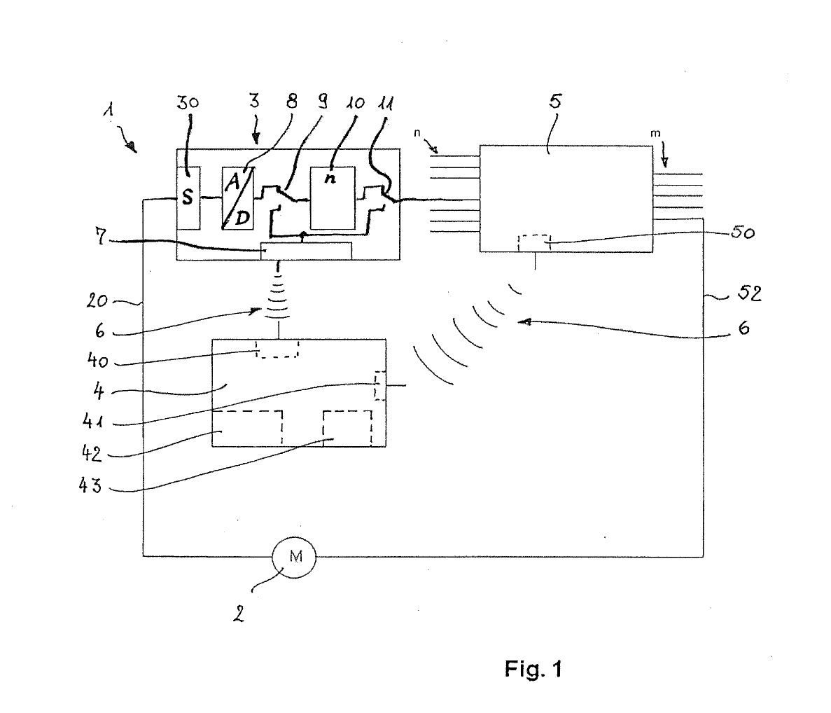

FIG. 1 a schematic diagram of an arrangement of the invention with a field device, a sensor, or signal, registering unit having a number of function blocks, a control system as well as a mobile computer unit of the invention, and

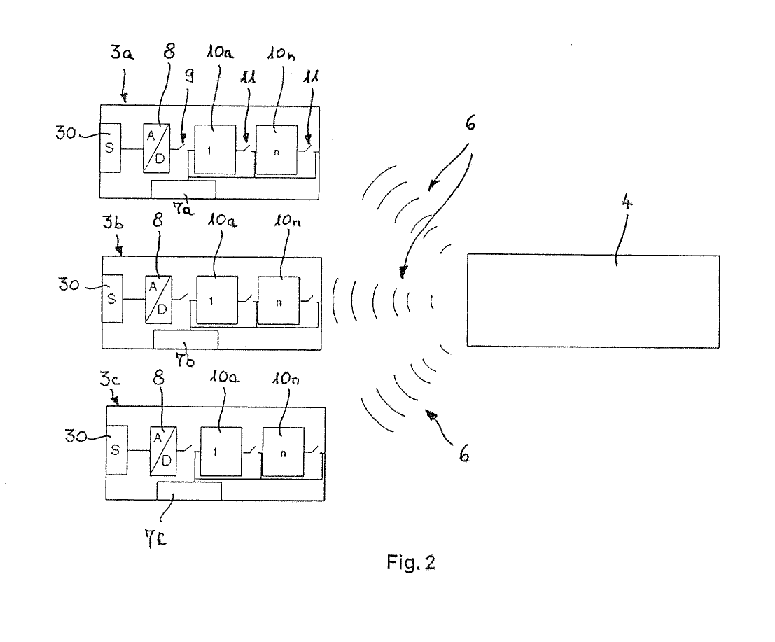

FIG. 2 a schematic diagram of an arrangement of the invention with a number of sensor, or signal, registering units and a mobile computer unit of the invention in wireless communication with one another.

FIG. 1 shows a schematic diagram of an arrangement 1 having a field device 2 in the form of a motor M, respectively a valve, respectively an actuator, a sensor, and signal, registering unit 3, a mobile computer unit 4 and a control system 5. Field device 2 is connected by cable with the sensor, and signal, registering unit 3 as well as the control system 5. The mobile computer unit 4 is connected wirelessly both with the sensor, or signal, registering unit 3 as well as also the control system 5. This wireless connection is indicated with reference characters 6. The wireless connection can be, for example, a radio, or infrared, connection or any other wireless connection. The sensor, or signal, registering unit 3 and the control system 5 are connected with one another via cable 51. The control system, especially a control room, has a number n of inputs and a number m of outputs. The inputs are, or can be, connected via individual cables with n sensor, or signal, registering units 3, and the outputs of the control system 5 with m field devices 2. The sensor, or signal, receiving unit 3 is connectable with a transmitting/receiving unit 7. Transmitting/receiving unit 7 serves for the wireless transmission of data and/or signals to, respectively from, the mobile computer unit 4. Especially, the transmitting/receiving unit 7 can be a radio unit.

The sensor, or signal, registering unit 3 includes a sensor part 30, which is connected with an analog-digital converter 8 for converting the analog signals, which are received from the field device 2 via a cable 20, into digital signals. The analog-digital converter 8 can be connected with the transmitting/receiving unit 7, in order to be able to transmit the digital signals to the mobile computer unit 4. For separating the sensor part 30 and analog-digital converter 8 from function blocks 10, an isolator or single pole double throw switch 9 is provided. Transmitting/receiving unit 7 can be connected with the plurality of function blocks 10. An accessing of the input of the function blocks 10 can, thus, occur via the wireless connection 6. For separating the function blocks 10 from the signal flow through this, a second isolator or single pole double throw switch 11 is provided, which does not, however, isolate the connection to the transmitting/receiving unit 7. Provided at the input and the output of the function blocks 10, can be single pole double throw switches, in order to prevent a turning off of the total signal flow in the case of the opening of the isolator 9 as a well as a shortcircuiting of the function blocks 10. Thus, the transmitting/receiving unit 7 can transmit the signals of the sensor part 30, respectively the signals of the analog-digital converter 8 to the mobile computer unit 4. The calculating occurs in the mobile computer unit 4, not in the function blocks 10. The results of the calculating by the mobile computer unit 4 are forwarded as stimuli to the control system 5. Conversely, signals can be sent from the mobile computer unit 4 to especially the function blocks 10 wirelessly via the transmitting/receiving unit 7. For wireless communication, also the mobile computer unit 4 includes a corresponding transmitted/receiving unit 40. It can, furthermore, have yet a second transmitting/receiving unit 41, in order to enable wireless communication with the control system. Alternatively, the wireless communication with both the control system 5 as well as also the sensor, or signal, registering unit 3 can occur via only one transmitting/receiving unit 40, respectively 41. Also control system 5 includes a transmitting/receiving unit 50 for wireless communication with the mobile computer unit 4. Furthermore, the control system 5 is connected with the sensor, or signal, registering unit 3 via a cable 51 and in FIG. 1 with the field device also via a further cable 52.

The control system can comprise, for example, a PLC module in combination with a computer unit and, in given cases, an Internet connection module, respectively WLAN module, respectively the already mentioned infrared-, radio- or other wireless connection. The PLC module provides a PLC based control unit for activating the at least one field device 2. Via the computer unit within the control system, evaluations and calculations can occur and via the WLAN module, respectively the Internet connection, a connection to the Internet can be created, in order to provide an opportunity for external control of the control system or, conversely, to be able to bring information via the Internet into the control system.

Also, the mobile computer unit 4 can comprise a WLAN module, respectively an Internet connection, in order to enable an access opportunity or communication via the Internet. Especially via such a WLAN connection also a communication with the control system can occur. Advantageously, the mobile computer unit 4 is provided with a memory unit 43, in order to be able to store the registered measured values as well as the calculated values and evaluations for documentation purposes. Furthermore, at least one display means 42 can be provided, in order to be able to display the values ascertained in the mobile computer unit. For example, such a display means 42 can be provided in the form of a display screen and/or a digital display.

The mobile computer unit enables checking of a signal transmission, or measuring, chain from the field device 2, respectively the therewith associated sensor, or signal, registering unit, through to the control system 5. In such case, first of all, the sensor, or signal, registering unit registers a signal of the field device 2 and transmits this wirelessly after closing of the isolator 9 via the transmitting/receiving unit 7 to the mobile computer unit 4. The mobile computer unit 4 calculates from the received signals a theoretical measured value. From the control system 5, the mobile computer unit 4 receives the current measured value of the field device 2 received there via the cable 51 and compares such with the theoretical measured value resulting from the calculating. From the comparison of the theoretical measured value and the current measured value, which the control system 5 has received, deductions can be made concerning whether there is error in the signal transmission, respectively measuring, chain between the sensor, or signal, registering unit 3 and the control system 5, wherein also all elements of the signal transmission, respectively measuring, chain, which are provided on the part of the control system 5, can be here included into the signal transmission, respectively measuring, chain and correspondingly taken into consideration in the error monitoring.

For SIL-measures, signals from the function blocks 10 are wirelessly transmitted via the transmitting/receiving unit 7 to the mobile computer unit 4. The mobile computer unit 4 ascertains therefrom an actual value and compares such with a predetermined, desired value, which is either given to the mobile computer unit 4 earlier, for example, by the control system 5, or stored in a memory of the mobile computer unit 4 as desired value. The mobile computer unit 4 performs, thus, the SIL-functionality otherwise implemented in the field device, so that this effort for the field device 2 can be omitted. A SIL-functionality can, thus, be retrofitted also in the case of existing field devices, wherein these need only be provided with a transmitting/receiving unit 7 for wireless communication with the mobile computer unit 4.

FIG. 2 shows that a mobile computer unit 4 can be arranged in the range of a plurality field of devices and a corresponding plurality of sensor, or signal, registering units 3a, 3b, 3c. Each of the units is provided with a respective transmitting-receiving unit 7a, 7b, 7c, in order to enable wireless communication with the mobile computer unit 4.

Each of the sensor, or signal, registering units 3a, 3b, 3c includes a number of function blocks 10a to 10n, as indicated in FIG. 2. The signals of the individual function blocks 10a to 10n are transmitted wirelessly to the mobile computer unit via the respective transmitting/receiving units 7a, 7b, 7c. Occurring in the mobile computer unit 4 is the calculating of the actual values as well as the desired value versus actual value comparison for the function blocks. Likewise, the mobile computer unit 4 can act in the case of detecting an error, thus either by making corrections or by turning the particular field device 2 completely off, or by bringing it into a safe state. Since the providing of the mobile computer unit 4 serves for implementing SIL-measures as regards the field device 2, the arrangement 1 is so designed that a ongoing communication between the field device 2 and the mobile computer unit 4 is provided. An interruption of the communication leads especially to output of an error signal. In given cases, the field device can transfer into a predetermined, safe state. If the mobile computer unit 4 is removed, it can likewise be provided that all field devices 2 actually in communication with the mobile computer unit 4 and addressed by the mobile computer unit 4 go into a defined, safe state.

Instead of isolation switches, which are shown in FIG. 2 between the function blocks 10a to n, also single pole double throw switches can be provided between the function blocks, such as shown in FIG. 1, so that, for example, an i+l-th block (0<1<n) can be selectively connected to the i th block or to the receiving unit 7.

Instead of the one mobile computer unit 4 shown in FIG. 2, also a plurality of mobile computer units 4 can be provided and used in connection with a plurality of field devices 2. In this way, the values ascertained by the respective mobile computers unit 4 can also be supplementally verified, respectively redundancies created, in order to increase safety further.

In the range of the respective transmitting/receiving units 7, 7a, 7b, 7c, 40, 41, 50, systems for encrypting the data and signals to be transmitted can be provided. Encryption systems provide significantly increased security against tinkering with the field devices, respectively the field device 2.

In order to check the sensor, or signal, registering units 3a, 3b, 3c and/or the A/D converter 8 as regards their functional ability, a stimulus can be produced on the output of the field device 2 and the reaction of the control system evaluated. In such case, it is advantageous that the behavior of the measuring path from the field device 2 to the control system 5 be known, so that the response of the sensor, or signal, registering units 3a, 3b, 3c can be predicted. In order then to check the accuracy of measurement the sensor, or signal, registering units 3a, 3b, 3c, the predicted value is compared with the measured value. The size of the, in given cases, resulting difference between these values is a measure for the accuracy of measurement the sensor, or signal, registering units 3a, 3b, 3c.

Besides determining the accuracy of measurement of the sensor, or signal, registering units, the applying of the stimulus also means that the behavior of the total measuring path can be checked and, in given cases, corrections made or, in given cases, correction factors taken into consideration in the calculations, when deviations from predeterminable desired values occur.

In the case of providing a memory unit in the mobile computer unit 4, the ascertained, respectively calculated, values can be stored, so that they are available as reference values for statistical purposes as well as for subsequent measurements, calculations and evaluations.

Besides the variants of arrangements described above and shown in the figures having at least one field device, the at least one sensor, or signal, registering unit and the associated at least one function block, numerous other embodiments can be provided, in the case of which, respectively, at least one mobile computer unit is provided for performing calculations and/or evaluations and the sensor, or signal, registering unit and the mobile computer unit comprise, in each case, at least one system for wireless sending and/or receiving of data and/or signals for wireless communication with one another.

### LIST OF REFERENCE CHARACTERS

1 arrangement
2 field device (motor/valve/actuator)
3 sensor, or signal, registering unit
3a sensor, or signal, registering unit
3b sensor, or signal, registering unit
3c sensor, or signal, registering unit
4 mobile computer unit
5 control system
6 wireless connection
7 transmitting/receiving unit
7a transmitting/receiving unit
7b transmitting/receiving unit
7c transmitting/receiving unit
8 A/D converter (analog/digital converter)
9 isolator, single pole single throw switch
10 function block
10a function block
10n function block
11 isolator, single pole single throw switch
20 cable
30 sensor part
40 transmitting/receiving unit
41 transmitting/receiving unit
42 display means
43 memory unit
50 transmitting/receiving unit
51 cable
52 cable

1. Arrangement (1) comprising at least one field device (2), at least one sensor, or signal, registering unit (3,3a,3b,3c) associated or associable therewith and at least one function block (10,10a,10n), characterized in that at least one mobile computer unit (4) is provided for performing calculations and/or evaluations and the at least one sensor, or signal, registering unit (3,3a,3b,3c) and the at least one mobile computer unit (4) comprise for wireless communication with one another, in each case, at least one system (7,7a,7b,7c,40) for wireless sending and receiving of data and/or signals.

2. Arrangement (1) as claimed in claim 1, characterized in that the mobile computer unit (4) includes at least one system (40,41) for wireless data communication with a control system (5), especially a control room.

3. Arrangement (1) as claimed in one of the preceding claims, characterized in that the system (7,7a,7b,7c) for the wireless sending and receiving of data and/or signals of the sensor, or signal, registering unit (3,3a,3b,3c) is connectable or connected with at least one function block (10,10a,10n) and/or a sensor part (30) of the sensor, or signal, registering unit (3,3a,3b,3c) for providing wireless access of the mobile computer unit (4) to the function block (10,10a,10n) and/or the sensor part (30).

4. Arrangement (1) as claimed in one of the preceding claims, characterized in that the mobile computer unit (4) includes at least one display means (42) and/or at least one memory means (43) and/or at least one wireless Internet connection system.

5. Arrangement (1) as claimed in one of the preceding claims, characterized in that encrypted data, and/or signal, transmission is provided.

6. Method for checking a measuring chain in a plant, comprising at least one field device (2), at least one sensor, or signal, registering unit (3) associated therewith and at least one control system (5), wherein the control system (5) is connected with the field device (2) and the sensor, or signal, registering unit (3) by at least one conductor (51) for receiving measured values, characterized in that the sensor, or signal, registering unit (3) registers a signal of the field device (2), transmits such to a mobile computer unit (4) wirelessly and the mobile computer unit (4) calculates therefrom a theoretical measured value and compares such with the current measured value of the field device (2) received at the control system (5).

7. Method as claimed in claim 6, characterized in that the mobile computer unit (4) receives the current measured value from the control system (5) wirelessly.

8. Method as claimed in claim 6 or 7, characterized in that, for the checking the sensor, or signal, registering unit (3) and/or an analog-digital converter unit (8) of the sensor, or signal, registering unit (3), a stimulus is produced on the output of the field device (2) and the measured response signal compared with a calculated signal of the sensor, or signal, registering unit (3).

9. Method for implementing SIL-measures in a plant comprising at least two field devices (2) with at least one respective, associated sensor, or signal, registering unit (3a,3b,3c) and at least two function blocks (10,10n), characterized in that a system (7a,7b,7c) for wireless sending and receiving signals of the function blocks (10,10n) wirelessly transmits to a mobile computer unit (4) and the mobile computer unit (4) calculates an actual value therefrom and compares such with a predeterminable or predetermined, desired value.

10. Method as claimed in claim 9, characterized in that a plurality of field devices (2) are arranged in range of the mobile computer unit (4) and obtain SIL-functionality via the mobile computer unit (4).
